(19) United States
(12) Patent Application Publication
(10) Pub. No.: US 2004/0172894 A1
(43) Pub. Date: Sep. 9, 2004

(54) Window screen fixing arrangement

(76) Inventor: Ross Doonan, Wilton (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/475,695

(22) PCT Filed: Jan. 12, 2001
(86) PCT No.: PCT/AU01/00033

(51) Int. Cl. E06B 3/26; E06B 1/04

(52) U.S. Cl. 52/204.1; 52/204.5

(57) ABSTRACT

A window framing system (1) adapted to incorporate an integral framed screen device (2). The system includes window frame components that define a screened opening (4), wherein at least two opposed sides of the frame components each include recessed retaining channels (7) and (8) that face into the opening and which are adapted to receive therein a portion of the frame of the screen device (2). The channels are respectively sized and spaced to facilitate loading of the screen into the channels by rotation and translation with an excess clearing within at least one of the channels, while enabling the screen to fully cover the opening when repositioned in an installed position in which the frame of the screen also extends into the other of said opposed channels. The system also includes means to captively retain the assembled screen in the installed position. In the preferred form of the invention adapted to incorporate an integral security screen device, the retaining means includes a retractable pin mechanism (11) that prevents translation of the screen within the channels thereby preventing its removal.

### FIELD OF THE INVENTION

The present invention relates to a window screen fixing arrangement and in a preferred form to a security screen fixing arrangement which is readily releasable from the inside.

The invention has been developed primarily for use with aluminium windows and will be described with reference to this field of use. However, it will be appreciated that the invention is equally applicable to windows formed of other materials, particularly PVC.

### BACKGROUND OF THE INVENTION

The fixing of insect screens and security screens to windows has most commonly been effected by screwing the screen itself, or screen retaining brackets, directly to the outer surface of the window frame. This has several disadvantages. For example, security screens have to comply with stringent forced entry resistance standards. These standards require that the fixings themselves must be tamper proof and further specify that the entire screen assembly must resist removal by application of a high tensile load to a corner of the screen, such as may be applied when the screen is pulled by a chain or cable secured to a vehicle or the like.

To meet these requirements, common practice has been to attach the security screen to the window frame using a plurality of screws having unidirectional drive heads. Whilst this has proven sufficient for the purposes of complying with the forced entry standards, it means that in the event of a fire where the security screen covers the entire window opening, egress through that window opening is impossible and the screen structure thereby poses a safety hazard. It is also generally accepted that unidirectional screws are no deterrent to skilled or experienced intruders.

Another problem with the prior art mounting of security screens and insect screens as described above, is that the screen becomes an unsightly surface “add on” to the window structure which often mars the overall aesthetics of the window assembly. Further, the use of tamper proof screws makes it extremely difficult to remove the screens for cleaning or decorating.

It is an object of the invention to provide a window screen fixing arrangement which overcomes or at least ameliorates one or more of the above discussed disadvantages of the prior art, or which offers a useful alternative.

### DISCLOSURE OF THE INVENTION

According to the invention there is provided a window framing system adapted to incorporate an integral framed screen device, said system including:

window frame components defining an opening to be screened, wherein at least two opposed sides of said frame components each include adjacent an outer edge thereof a recessed retaining channel facing into said opening that is adapted to receive therein a portion of the frame of the screen device,

said channels being respectively sized and spaced to facilitate loading of the screen into the channels by rotation and translation within excess clearance within at least one of the channels, while enabling the screen to fully cover the opening when repositioned in an installed position in which the frame of the screen also extends into the other of said opposed channels, and

means to captively retain the assembled screen in the installed position.

Preferably the depth of one of said channels is greater than twice the depth of the opposing channel.

In one preferred form where the screen is an insect screen, the means to captively retain the assembled screen in the installed position includes one or more leaf spring type mechanisms that operate against the inner surface of a channel to resiliently bias the screen upon installation to an installed position wherein both sides of the screen frame are disposed within and retained by the opposed channels.

In another form, where the screen is preferably a security screen, the means to captively retain the assembled screen in the installed position includes a retractable pin mechanism that prevents translation of the screen within the channels thereby preventing removal. In one form the pin is biased into an unlocked position and when locked retains the screen by blocking releasing travel of the screen within that channel. In another form the pin may engage an opening in the screen frame. Desirably, the security screen may also include an integral insect screen.

Preferably, the deeper of said channels is the securing channel in which the retaining means operates. In most embodiments, this deeper securing channel will form part of the lock stile jamb.

Desirably, the channels are configured for optional alternative use as a glazing channel thereby minimising the total number of frame components within a framing range.

In one preferred form configured for use with a sliding window arrangement, the retaining channel is formed in the lock stile jamb and the opposing channel is formed in the fixed interlock, such that the glazing of the fixed sash is substantially coplanar with the installed screen of the opening sash.

### BRIEF DESCRIPTION OF THE DRAWINGS

Preferred embodiments of the invention will now be described, by way of example only, with reference to the accompanying drawings in which:

FIG. 1 is a perspective view of a first embodiment window framing system according to the invention incorporating an integral framed security screen device illustrated in the unlocked position;

FIG. 2 shows the window securing screen framing system of FIG. 1 in the locked position;

FIG. 3 is a cutaway perspective part view of the system of FIGS. 1 and 2;

FIG. 4 is a full cross sectional view of a securing screened sliding window system as illustrated in the previous figures with the security screen shown in the fixed or installed position;

FIG. 5 is a cross sectional view of the window framing system shown in FIG. 4 illustrating the first stage of removal of the security screen;

FIG. 6 is a sectional view of the assembly shown in FIGS. 4 and 5 illustrating the final stage of removal of the security screen;

FIG. 7 is a perspective part view of a second embodiment window framing system according to the invention incorporating an integral framed insect screen device illustrated in the unassembled position; and

FIG. 8 illustrates the second embodiment assembly of FIG. 7 shown in the installed position.

### PREFERRED EMBODIMENTS OF THE INVENTION

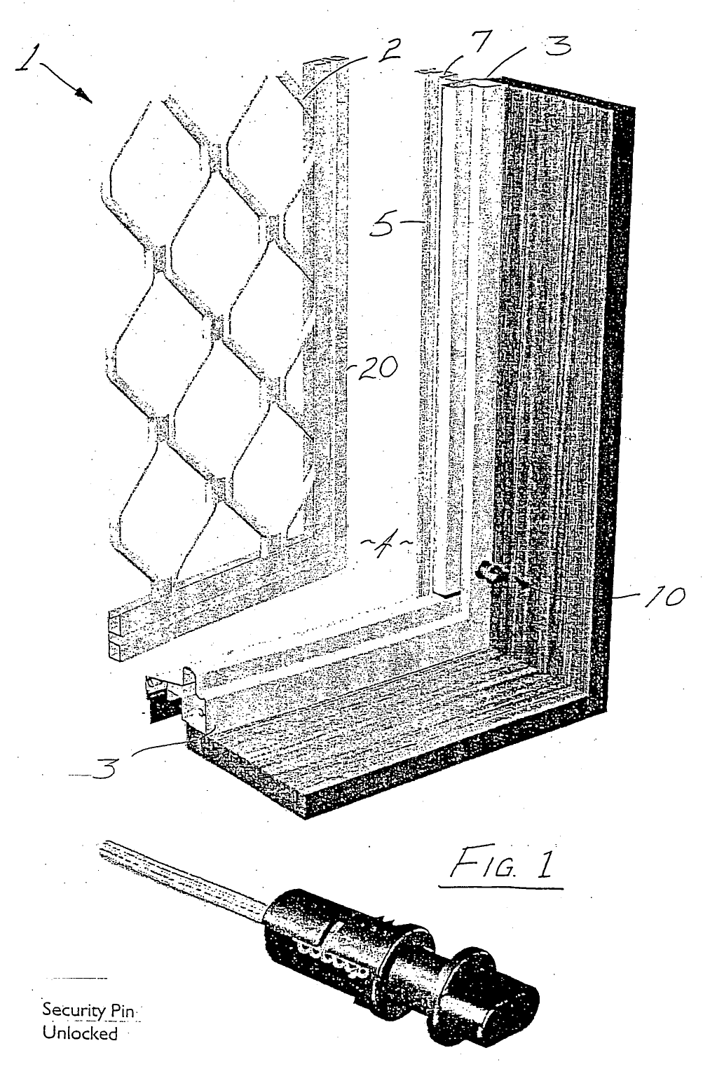

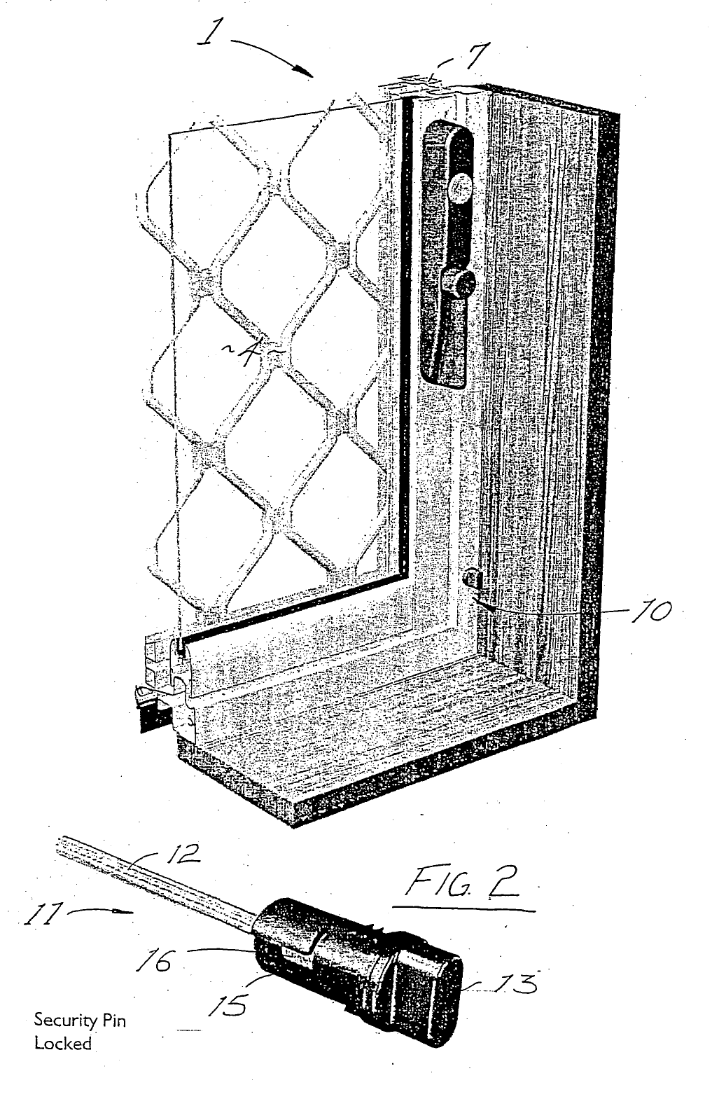

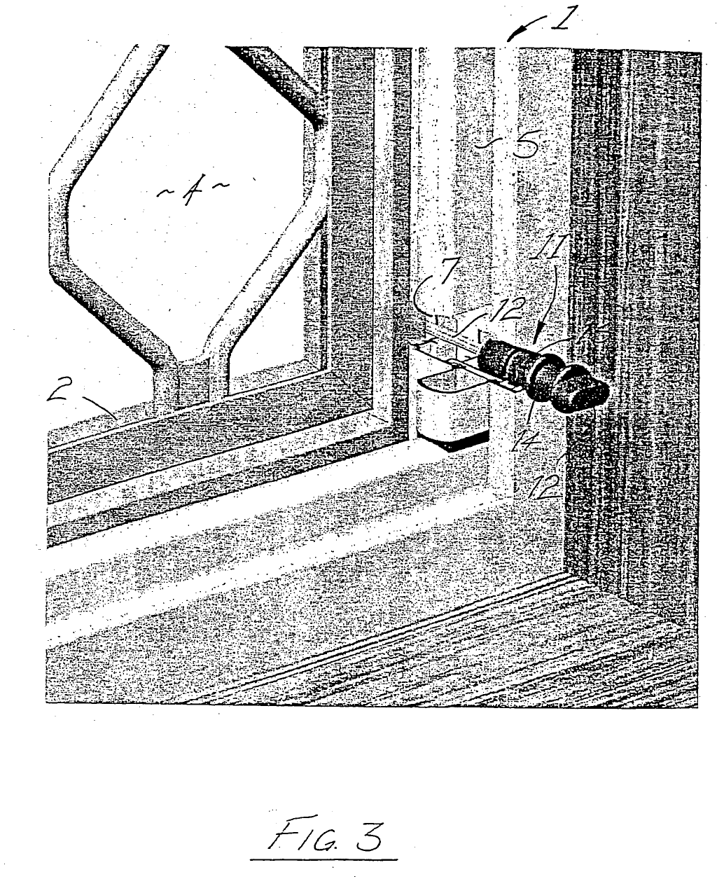

Referring firstly to FIGS. 1 to 6, there is shown a first embodiment window framing system according to the invention shown generally at 1 that incorporates an integral framed security screen device 2.

The framing system 1 includes a plurality of framing components 3 which in combination define a screened opening 4.

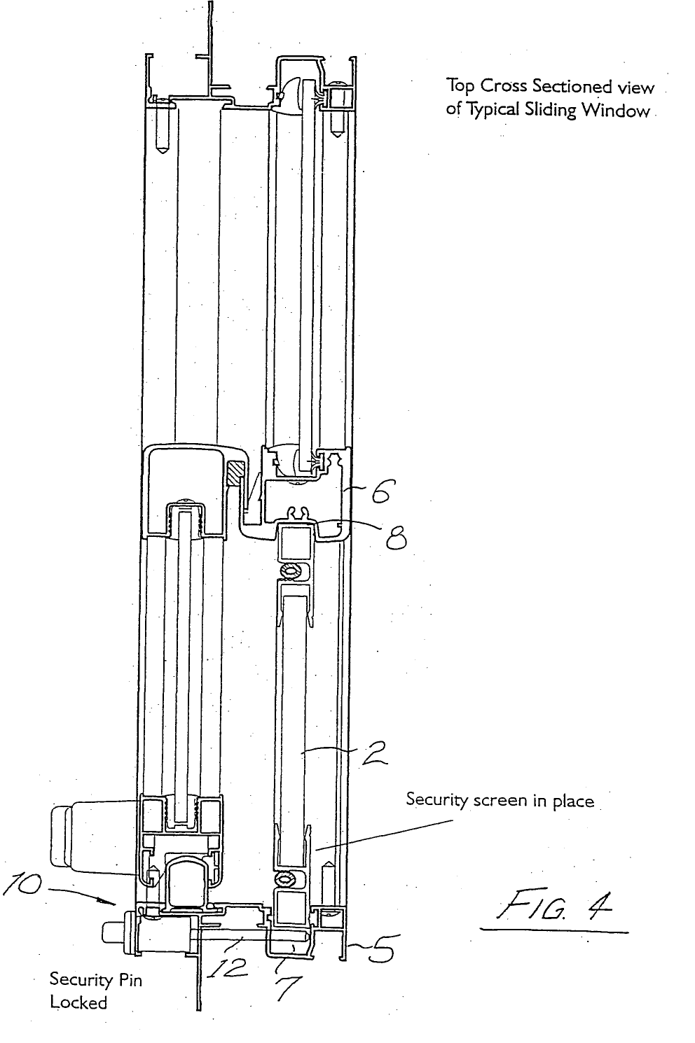

As is best shown in FIGS. 4 to 6, the screened opening is bounded, in the preferred form shown, by two vertically opposed side members, the lock stile jamb 5 and the interlock stile 6. Each of these opposed side frame components include recessed retaining channels marked 7 and 8 respectively.

The retaining channel 7 on the jamb has a depth that is greater than twice the depth of the opposing retaining channel 8 in the fixed interlock and this deeper channel is hereafter referred to as the securing channel.

Also forming part of the framing system 1, is a means to captively retain the screen in an installed position which is generally indicated at 10. In this first embodiment which incorporates a framed security screen 2, this retaining means includes a releasably lockable security pin device 11.

This security pin device includes a pin 12 having a locking button 13 at one end. Extending from the locking button 13 is a cylindrical plunger 14 that slides within an outer cylindrical housing 15. Disposed within the housing is a helical compression spring 16 which is retained at its innermost end within the housing and is compressed by action of the cylindrical plunger 14 that extends from the locking button 13. A simple bayonet stile locking mechanism is shown generally at 17 which operates to secure the cylindrical plunger 14 to the outer cylinder housing 15 when the pin is depressed against the spring and rotated accordingly.

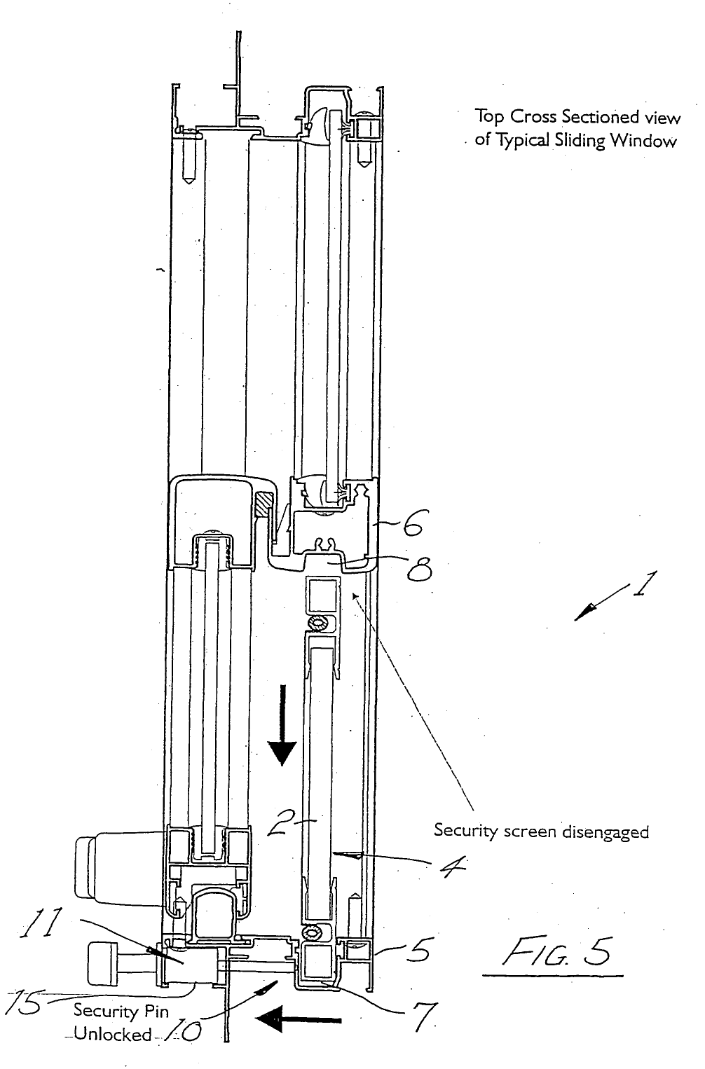

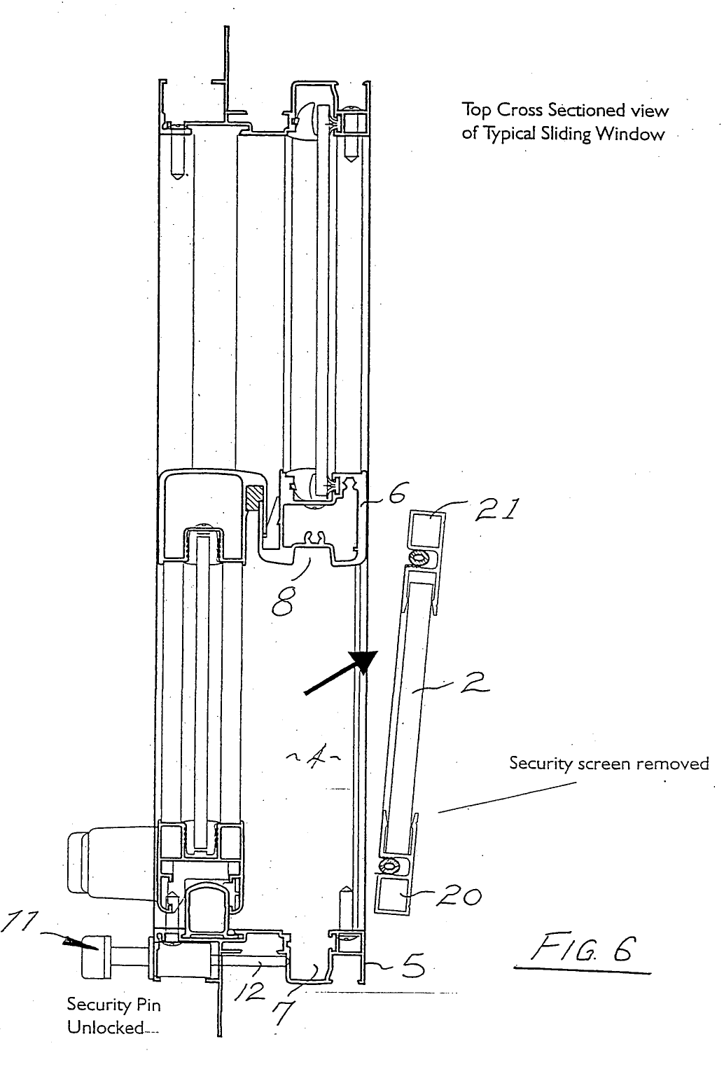

In use, the security screen is assembled into the opening 4 by the reverse operation of the process shown in FIGS. 5 and 6. That is, a first leading edge 20 of the framed screen 2 is inserted into the securing channel 7 within the lock stile jamb 5. This is done by a combined rotational and translational movement. Once the leading edge 18 is fully home within the base of the securing channel 7, the screen can be aligned with the opposing retaining channel 8. The screen is then moved sideways within the plane of the opening so that the trailing edge 21 of the screen 2 sits fully in the second channel as shown in FIG. 4.

In this position both the leading and trailing edges of the screen are within the channels 7 and 8 preventing direct outward removal of the screen from the framing system. To retain the security screen in this position, the security pin device (shown unlocked in FIGS. 5 and 6) is depressed inwardly against the spring 16 until the distal end 22 of the pin extends fully into the base of the securing channel 7. The locking button 13 can then be rotated 90° to lock the button in that depressed position via the locking mechanism 17.

This solution has numerous advantages. Firstly, the screen forms an integral part of the framing system and thereby does not suffer the aesthetic shortcomings of the prior art. More importantly, the security pin locking mechanism provides a very simple to operate security device which is also extremely reliable, as any load against the pin will be applied in shear making it extremely difficult to break.

Equally as important, the screen can be readily removed from inside the building in the event of an emergency such as a fire without using keys or removing screws. It is similarly easy to remove the screens for cleaning and redecorating purposes. Another advantage of the preferred form shown is that the retaining channels 7 and 8 can double as glazing channels thereby keeping the total number of frame components to a minimum. Further, it ensures flush alignment of the screen with adjacent fixed glazed portions.

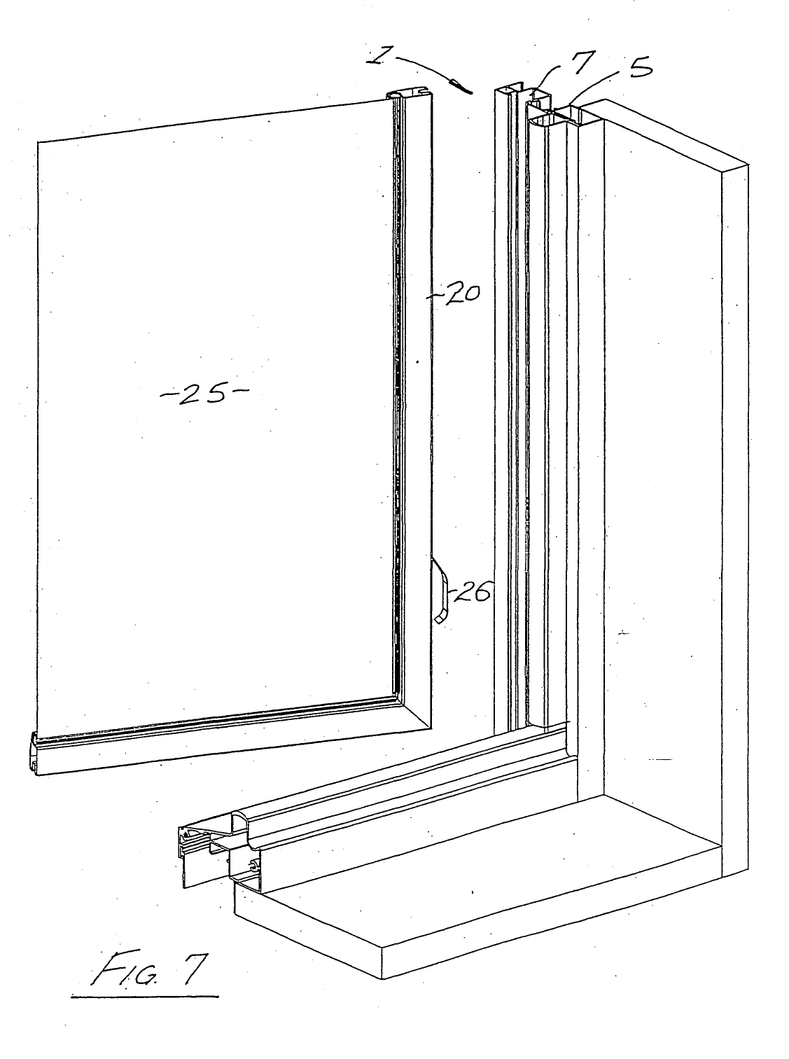

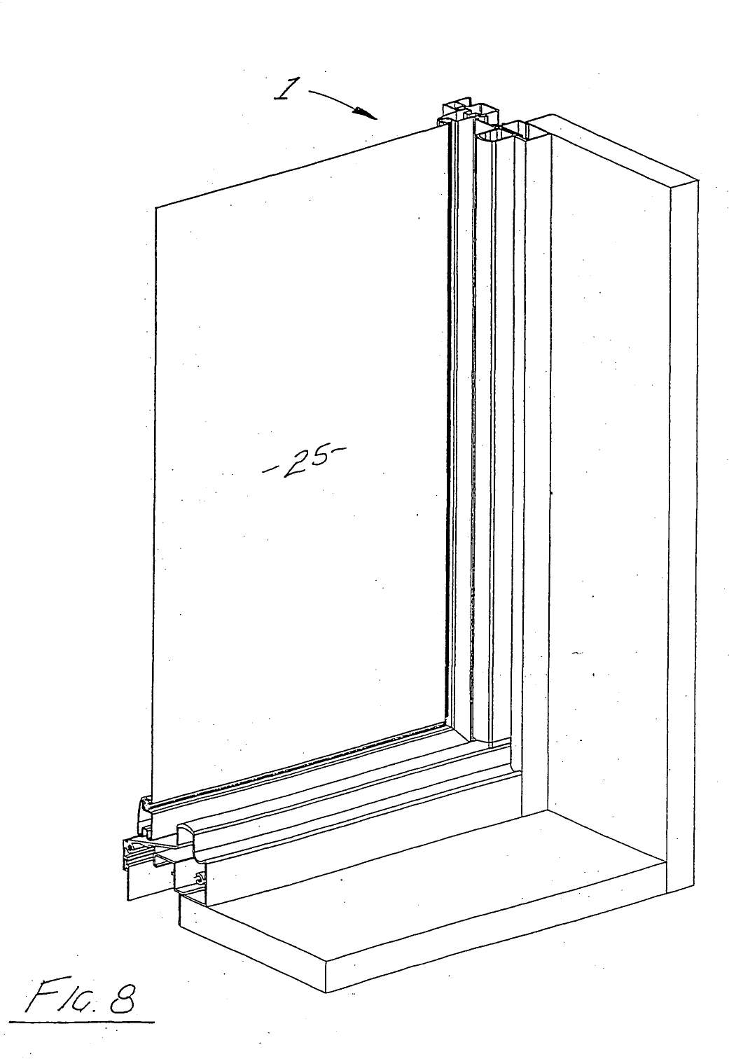

Referring finally to FIGS. 7 and 8, a second embodiment of the invention is illustrated that is configured for incorporating insect screens that do not require a security locking device. Where possible like reference numerals have been used to denote corresponding features.

The primary differences between the embodiments, is that the insect screen 25 is retained between the opposing channels (of which only channel 7 that is in the lock stile jamb is shown) by means of simple biasing leaf springs 26. These operate against the internal surface of the securing channels 7 to bias the opposing edge of the insect screen into engagement with the opposing channel. To install and remove the screen, it is simply slid sideways to compress the spring until the opposing edge of the screen can be removed from the other retaining channel.

It will be noted that the security screen 2 referenced in the first embodiment also includes an integral insect screen element designated at 23.

While preferred embodiments have been described that relate specifically to aluminium windows, it will be appreciated by those skilled in the art that the invention is equally applicable to windows constructed from other materials. Similarly, it will be appreciated that the broad inventive concept may be embodied in a variety of other physically different forms.

1. A window framing system adapted to incorporate an integral framed screen device, said system including:
window frame components defining an opening to be screened, wherein at least two opposed sides of said frame components each include adjacent an outer edge thereof a recessed retaining channel facing into said opening that is adapted to receive therein a portion of the frame of the screen device,
said channels being respectively sized and spaced to facilitate loading of the screen into the channels by rotation and translation within excess clearance within at least one of the charnels, while enabling the screen to fully cover the opening when repositioned in an installed position in which the frame of the screen also extends into the other of said opposed channels, and
means to captively retain the assembled screen in the installed position.

2. A window framing system according to claim 1 wherein the depth of one of said channels is greater than twice the depth of the opposing channel.

3. A window framing system according to claim 1 or claim 2 wherein the framed screen device is an insect screen and the means to captively retain the assembled screen in the installed position includes one or more leaf spring type mechanisms that operate against the inner surface of a channel to resiliently bias the screen upon installation to an installed position wherein both sides of the screen frame are disposed within and retained by the opposed channels.

4. A window framing system according to claim 1 or claim 2 wherein the screen is a security screen, and the means to captively retain the assembled screen in the installed position includes a retractable pin mechanism that prevents translation of the screen within the channels thereby preventing removal.

5. A window framing system according to claim 4 wherein the pin is biased into an unlocked position and when locked retains the screen by blocking releasing travel of the screen within that channel.

6. A window framing system according to claim 4 or claim 5 wherein the security screen includes an integrally secured insect screen mesh.

7. A window framing system according to claim 1 wherein the deeper of said channels is the securing channel in which the retaining means operates.

8. A window framing system according to claim 7 wherein the deeper securing channel is formed as part of the lock stile jamb.

9. A window framing system according to claim 1 wherein the channels are configured for optional alternative use as a glazing channel thereby minimising the total number of frame components within a frame range.

10. A window framing system according to claim 1 that is configured for use with a sliding window arrangement, the retaining channel being formed in the lock stile jamb and the opposing charnel being formed in the fixed interlock.

11. A window framing system according to claim 10 wherein the glazing of the fixed sash is substantially coplanar with the installed screen of the opening sash.

12. A window framing system according to claim 1 including an integral framed security screen device.

13. A window framing system according to claim 1 incorporating an integral framed insect screen device.
